(19) United States
(12) Patent Application Publication
(10) Pub. No.: US 2026/0288563 A1
(43) Pub. Date: Sep. 24, 2026

(54) HARDWARE ACCESS METHOD FAILURE RECOVERY

(71) Applicant: Dell Products L.P., Round Rock, TX (US)

(72) Inventors: Alan Helmy Abdelhalim, Pflugerville, TX (US); Jacob Vincent Mink, Cedar Park, TX (US); Ibrahim Sayyed, Georgetown, TX (US)

(21) Appl. No.: 19/083,902

(22) Filed: Mar. 19, 2025

(51) Int. Cl. G06F 11/07

(52) U.S. Cl. CPC G06F 11/0778; G06F 11/0781; G06F 11/079

(57) ABSTRACT

An embodiment selects a first access method from an access method priority list. An embodiment. An embodiment requests, using the first access method, data from a first hardware component of an information handling system. An embodiment detects, from a firmware level return code received in response to the request using the first access method, an unavailability of the first access method. An embodiment selects, responsive to detecting an unavailability of the first access method, a second access method from the access method priority list. An embodiment requests, using the second access method, data from the first hardware component.

### BACKGROUND

### Field of the Disclosure

The disclosure relates generally to an information handling system, and in particular, to hardware access method failure recovery.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems incorporate a telemetry manager, a software platform incorporating telemetry, cloud-based analytics, and data transmission to monitor and report status of the information handling system and its components. Automatically collecting and analyzing telemetry helps an information handling system supplier accurately and efficiently diagnose issues on customer devices and provide the right solutions on the first try and decreases productivity interruption by proactively predicting or detecting device health issues before or as soon as they arise. The telemetry manager supports on-demand, periodic, and event or trigger-based data workflows across collection, analytics, and transmission data operations. The telemetry manager is single-instanced and shared by information handling system management applications and services to optimize performance on user systems. Client application software development kids (SDKs) present a declarative, data-oriented perspective, prioritizing discoverability and ease of use by data scientists and application developers. The platform provides a secure, “Local Data Lake” on the information handling system including raw collected data, locally-computed analytics, and diagnostic test results. Offloading work to a cloud-based system enables faster, actionable insights computed locally and reduces the amount of data transmitted to the cloud by default. The platform provides extensibility mechanisms that allow platform extendibility via new or updated analytics plug-ins. The platform provides a management model where individual “datatypes” have associated configuration settings used to dynamically optimize the frequency of their collection, computation, and transmission. The platform defines a core set of telemetry to be collected/computed and transmitted by default, with the rest lying in dormant mode, available to produce and transmit per optional administrator configuration or client requests. The platform supports client application configuration profiles and batch requests that allow applications to easily configure their periodic or ongoing telemetry and analytics requirements or batch on-demand requests. The platform merges application requests to single-instance and optimizes operations without further application input.

### SUMMARY

Innovative aspects of the subject matter described in this specification may be embodied in a method comprising: selecting a first access method from an access method priority list; requesting, using the first access method, data from a first hardware component of an information handling system; detecting, from a firmware level return code received in response to the request using the first access method, an unavailability of the first access method; selecting, responsive to detecting an unavailability of the first access method, a second access method from the access method priority list; and requesting, using the second access method, data from the first hardware component.

Other embodiments of these aspects include corresponding systems, apparatus, and computer programs, configured to perform the actions of the methods, encoded on computer storage devices.

Particular implementations of the subject matter described in this specification can be implemented so as to realize one or more of the following advantages. For example, the implementations meet a need to reduce access failures as much as possible, improving the user experience.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 depicts a block diagram of an example configuration for hardware access method failure recovery, in accordance with an illustrative embodiment.

FIG. 3 depicts an example of hardware access method failure recovery, in accordance with an illustrative embodiment.

FIG. 4 depicts an example of hardware access methods for use in hardware access method failure recovery, in accordance with an illustrative embodiment.

FIG. 5 depicts a flowchart of an example process for hardware access method failure recovery. in accordance with an illustrative embodiment.

### DESCRIPTION OF PARTICULAR EMBODIMENT(S)

A telemetry manager in presently available information handling systems requires communication with a system's hardware components such as the battery, fan, and thermal monitoring. For example, a system optimizer application might use the telemetry manager to gather current information about the battery status on a system to optimize the system's charge mode. To access this battery information, the telemetry manager must make one or several calls using a firmware/hardware access interface. Often several different interfaces are available, with different speeds and capabilities. Due to several different conditions, access methods may fail temporarily or fail forever. Delivered bugs across firmware versions, component-level failures, intermittent electrical conditions, and other kinds of events can cause access failures which can lead to missing data, performance degradation, or impacts to the user experience. Thus, the illustrative embodiments recognize that there is a need to reduce access failures as much as possible, improving the user experience.

This disclosure discusses methods and systems for hardware access method failure recovery of an information handling system. In particular, an embodiment selects a first access method from an access method priority list; requests, using the first access method, data from a first system component; detects, from a firmware level return code received in response to the request using the first access method, an unavailability of the first access method; selects, responsive to detecting an unavailability of the first access method, a second access method from the access method priority list; and requests, using the second access method, data from the first system component.

A telemetry manager platform includes one or more data services. A data service of the telemetry manager platform produces data. For example, a data manager service stores and manages historical, i.e., already collected, data. A telemetry collection service collects new data upon request via a commodity management service, which accesses information system handling components such as a fan, battery, or temperature sensor. An analytics service produces analytics or analysis results from historical or new data. The data manager service is also able to transmit data off-system, for example to an information handling system in a cloud environment, via a data transmission service.

Within the telemetry manager platform, the commodity management service communicates with components such as a fan, battery, or temperature sensor using one or more hardware component access methods. These hardware component access methods are centralized into a component called Common Platform Services, an operating system-level component with the ability to communicate with Basic Input/Output System (BIOS) / embedded controller (EC) protocols. Common Platform Services is an abstraction that enables use of the BIOS/EC protocols for telemetry and control. As information handling systems have evolved, the systems often support more than one hardware component access method. Executing within Common Platform Services, an embodiment maintains an access method priority list. The access method priority list prioritizes access methods to one or more hardware components. The access method priority list is prioritized such that the least impactful (e.g., fastest) methods to a system are a higher priority than more reliable but higher impact methods. In one embodiment, access methods are prioritized according to the technology used to perform the communication. Methods in the access method priority list are also categorized based on the component-level access performed (e.g., battery, fan, thermal monitoring, and the like).

For example, some information handling systems support three hardware component access methods. The slowest access method requires use of context switching into system management mode (SMM) via a system management interrupt (SMI) to transfer data and thus referred to as a high SMI usage interface. An interface with intermediate SMI usage and thus intermediate speed is a one-byte interface with less SMI usage than the slowest access method. The highest-bandwidth hardware component access method is a 256-byte interface that does not use SMI.

In one embodiment, methods in the access method priority list are predetermined, for example by a system engineer during system development. Another embodiment uses, as the methods in the access method priority list, the interface capabilities published by the system's Basic Input/Output System (BIOS) at boot time. Other methods of assembling contents of the access method priority list are also possible and contemplated within the scope of the illustrative embodiments.

An embodiment receives a request to access a system component. To access the system component, an embodiment selects the highest-priority access method from an access method priority list that is not tagged as having failed previously. Thus, if no failures have occurred or any previous failures have been cleared (in a manner described elsewhere here), an embodiment selects the highest-priority access method applicable to the system component or the system component's type from an access method priority list. For example, to access a system fan, an embodiment might select the method denoted as (1, fan). Using the first access method, an embodiment requests data from the system component. Continuing the fan example, an embodiment might call the method denoted as (1, fan).

An embodiment detects, from a firmware level return code received in response to the request using the first access method, an unavailability of the first access method. An embodiment also detects an unavailability of the first access method if a fatal error occurs requiring a system reboot (e.g., a blue screen of death or BSOD). An embodiment also categorizes, based on a firmware level return code, a hardware access failure as transient or permanent, and tags, or records, the access method and component that led to be failure accordingly in the access method priority list. A transient failure means that some temporary condition is causing the hardware access method to fail right now, but the failure might not happen at the next access call. One non-limiting example of a transient failure is a “no charger was present” return code when attempting to read data about the charge speed, as the failure might not happen once a charger is plugged into a system. A permanent failure means that a permanent condition is causing the hardware access method to fail. An embodiment always categorizes a fatal error as a permanent (rather than a transient) failure. One non-limiting example of a permanent failure is “object or method doesn't exist” return code, which can occur if a BIOS does not support a particular access method and hence the access method is not exposed to the operating system for use. Continuing the fan example, if an embodiment detects that the method denoted as (1, fan) has failed, the embodiment tags (1, fan) with a transient or permanent failure tag.

Responsive to detecting an unavailability of the first access method, an embodiment selects a second access method from the access method priority list and, using the second access method, requests data from the first system component. In embodiments, the second access method is the next-highest priority method in the list. Continuing the fan example, if an embodiment detects that the method denoted as (1, fan) has failed, the embodiment might call the method denoted as (2, fan).

An embodiment receives a second request to access the system component. To access the system component, an embodiment selects the highest-priority access method from an access method priority list that is not tagged as having failed previously. Thus, if the highest-priority access method is marked as having failed, an embodiment selects the next-highest-priority access method and proceeds as described herein. Thus, continuing the fan example, if the method denoted by (1, fan) is marked as having previously failed, an embodiment uses the method denoted by (2, fan) to access the system component.

One embodiment tracks access methods applicable to each type of system component. For example, if the method denoted as (1, fan) is tagged as having failed when accessing one system fan and the system has two fans, an embodiment might use the method denoted as (2, fan) to access both fans. Another embodiment tracks access methods applicable to each system component. For example, if the method denoted as (1, fan1) is tagged as having failed when accessing one system fan and the system has two fans, an embodiment might use the method denoted as (2, fan1) to access the first fan (which previously failed) and use (1, fan2) to access the second fan (which did not previously fail).

An embodiment clears a transient failure upon detecting that a system reboot has occurred since the transient failure occurred. An embodiment also clears a transient failure if the access method was used to successfully access a different system component.

Note that some hardware access methods are actually enumeration methods, i.e. including an enumeration of all devices in category X through an access method of priority N. Enumeration methods are exempt from the transient failure process. If an enumeration of priority N for a device in category X ever succeeds, all the other methods in the enumeration can be unblocked. In other words, “top-level” enumeration methods should always be tried. If an enumeration method from method set X ever succeeds, any transient failures from methods in set X are cleared, thereby enabling all the methods in method set X to be tried again during the normal priority resolution algorithm.

An embodiment clears a permanent failure upon detecting a firmware change in the system including a system component being accessed, because the firmware change is likely to have resolved the cause of the permanent failure.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

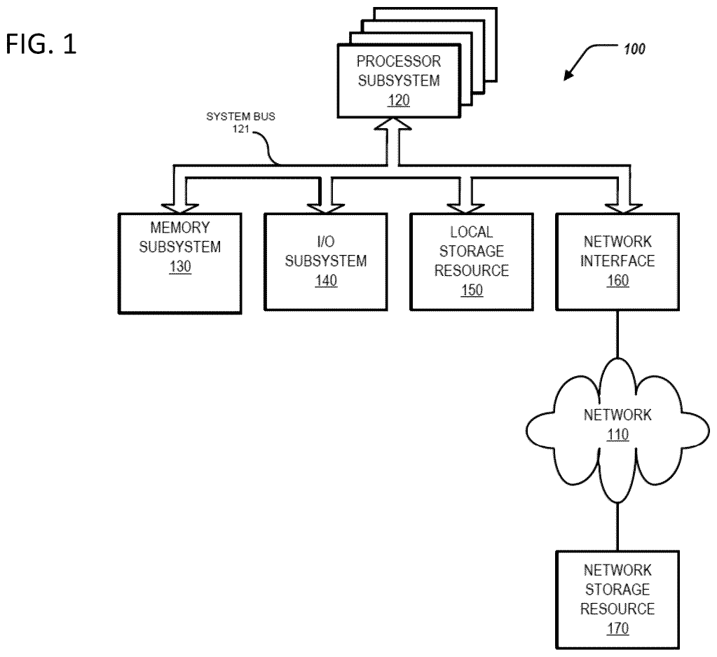

Particular embodiments are best understood by reference to FIGS. 1-5 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a software application implementing hardware access method failure recovery. The software application can be included by the memory subsystem 130. The software application can include a computer-executable program (software). The software application can be executed by the processor subsystem 120.

The information handling system 100 can also include a second software application implementing embedded controller functionality. The second software application can be in communication with the processor subsystem 120 or included in the processor subsystem 120. In some examples, the second software application is included by an embedded controller (EC) of the information handling system 100. In some examples, the second software application is included by baseband management controller of the information handling system 100.

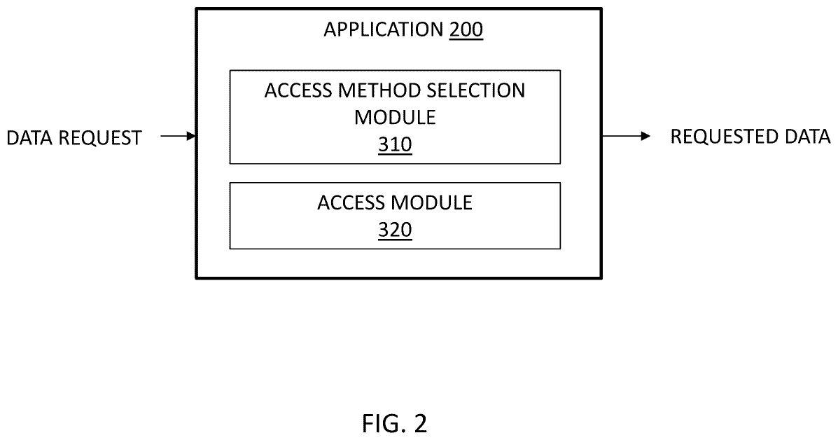

FIG. 2 depicts a block diagram of an example configuration for hardware access method failure recovery, in accordance with an illustrative embodiment. Application 200 executes in information handling system 100 of FIG. 1.

Within information handling system 100, a telemetry manager platform includes one or more data services. A data service of the telemetry manager platform produces data. For example, a data manager service stores and manages historical, i.e., already collected, data. A telemetry collection service collects new data upon request via a commodity management service, which accesses information system handling components such as a fan, battery, or temperature sensor. An analytics service produces analytics or analysis results from historical or new data. The data manager service is also able to transmit data off-system, for example to an information handling system in a cloud environment, via a data transmission service.

Within the telemetry manager platform, the commodity management service communicates with components such as a fan, battery, or temperature sensor using one or more hardware component access methods. These hardware component access methods are centralized into a component called Common Platform Services, an operating system-level component with the ability to communicate with Basic Input/Output System (BIOS) / embedded controller (EC) protocols. Common Platform Services is an abstraction that enables use of the BIOS/EC protocols for telemetry and control. As information handling systems have evolved, the systems often support more than one hardware component access method. Executing within Common Platform Services, access method selection module 210 maintains an access method priority list. The access method priority list prioritizes access methods to one or more hardware components. The access method priority list is prioritized such that the least impactful (e.g., fastest) methods to a system are a higher priority than more reliable but higher impact methods. In one implementation of module 210, access methods are prioritized according to the technology used to perform the communication. Methods in the access method priority list are also categorized based on the component-level access performed (e.g., battery, fan, thermal monitoring, and the like).

For example, some information handling systems support three hardware component access methods. The slowest access method requires use of context switching into system management mode (SMM) via a system management interrupt (SMI) to transfer data and thus referred to as a high SMI usage interface. An interface with intermediate SMI usage and thus intermediate speed is a one-byte interface with less SMI usage than the slowest access method. The highest-bandwidth hardware component access method is a 256-byte interface that does not use SMI.

In one implementation of module 210, methods in the access method priority list are predetermined, for example by a system engineer during system development. Another implementation of module 210 uses, as the methods in the access method priority list, the interface capabilities published by the system's Basic Input/Output System (BIOS) at boot time. Other methods of assembling contents of the access method priority list are also possible.

Application 200 receives a request to access a system component. To access the system component, module 210 selects the highest-priority access method from an access method priority list that is not tagged as having failed previously. Thus, if no failures have occurred or any previous failures have been cleared (in a manner described elsewhere here), module 210 selects the highest-priority access method applicable to the system component or the system component's type from an access method priority list. For example, to access a system fan, module 210 might select the method denoted as (1, fan). Using the first access method, access module 220 requests data from the system component. Continuing the fan example, module 220 might call the method denoted as (1, fan).

Module 210 detects, from a firmware level return code received in response to the request using the first access method, an unavailability of the first access method. Module 210 also detects an unavailability of the first access method if a fatal error occurs requiring a system reboot (e.g., a blue screen of death or BSOD). Module 210 also categorizes, based on a firmware level return code, a hardware access failure as transient or permanent, and tags, or records, the access method and component that led to be failure accordingly in the access method priority list. A transient failure means that some temporary condition is causing the hardware access method to fail right now, but the failure might not happen at the next access call. One non-limiting example of a transient failure is a “no charger was present” return code when attempting to read data about the charge speed, as the failure might not happen once a charger is plugged into a system. A permanent failure means that a permanent condition is causing the hardware access method to fail. Module 210 always categorizes a fatal error as a permanent (rather than a transient) failure. One non-limiting example of a permanent failure is “object or method doesn't exist” return code, which can occur if a BIOS does not support a particular access method and hence the access method is not exposed to the operating system for use. Continuing the fan example, if Module 210 detects that the method denoted as (1, fan) has failed, the embodiment tags (1, fan) with a transient or permanent failure tag.

Responsive to detecting an unavailability of the first access method, module 210 selects a second access method from the access method priority list and, using the second access method, module 220 requests data from the first system component. In implementations of module 210, the second access method is the next-highest priority method in the list. Continuing the fan example, if module 210 detects that the method denoted as (1, fan) has failed, module 220 might call the method denoted as (2, fan).

Application 200 receives a second request to access the system component. To access the system component, module 210 selects the highest-priority access method from an access method priority list that is not tagged as having failed previously. Thus, if the highest-priority access method is marked as having failed, module 210 selects the next-highest-priority access method and proceeds as described herein. Thus, continuing the fan example, if the method denoted by (1, fan) is marked as having previously failed, module 220 uses the method denoted by (2, fan) to access the system component.

One implementation of module 210 tracks access methods applicable to each type of system component. For example, if the method denoted as (1, fan) is tagged as having failed when accessing one system fan and the system has two fans, module 210 might select the method denoted as (2, fan) to access both fans. Another implementation of module 210 tracks access methods applicable to each system component. For example, if the method denoted as (1, fan1) is tagged as having failed when accessing one system fan and the system has two fans, module 210 might select the method denoted as (2, fan1) to access the first fan (which previously failed) and select (1, fan2) to access the second fan (which did not previously fail).

Module 210 clears a transient failure upon detecting that a system reboot has occurred since the transient failure occurred. Module 210 also clears a transient failure if the access method was used to successfully access a different system component.

Note that some hardware access methods are actually enumeration methods, i.e. including an enumeration of all devices in category X through an access method of priority N. Enumeration methods are exempt from the transient failure process. If an enumeration of priority N for a device in category X ever succeeds, all the other methods in the enumeration can be unblocked. In other words, “top-level” enumeration methods should always be tried. If an enumeration method from method set X ever succeeds, any transient failures from methods in set X are cleared, thereby enabling all the methods in method set X to be tried again during the normal priority resolution algorithm.

Module 210 clears a permanent failure upon detecting a firmware change in the system including a system component being accessed, because the firmware change is likely to have resolved the cause of the permanent failure.

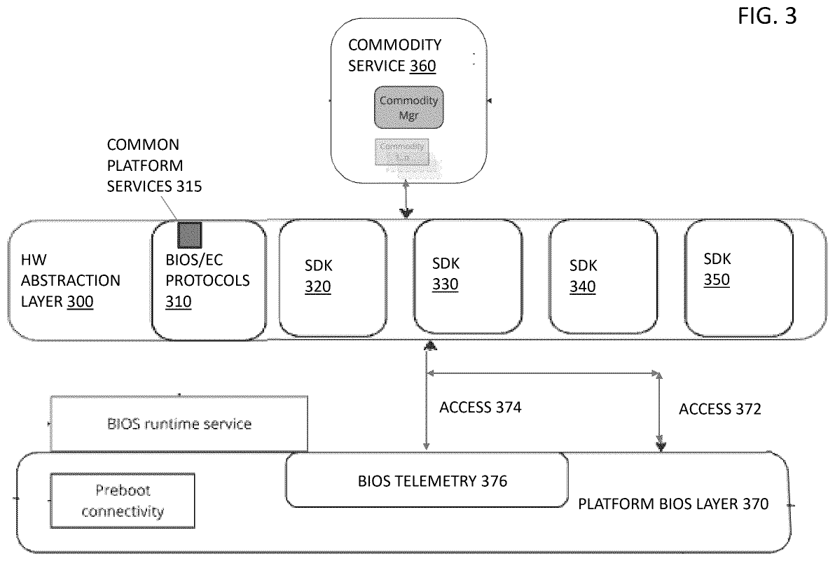

FIG. 3 depicts an example of hardware access method failure recovery, in accordance with an illustrative embodiment. The example can be executed using application 200 in FIG. 2.

Within a telemetry manager platform, commodity management service 360 communicates via modules in hardware (HW) abstraction layer 300 with components such as a fan, battery, or temperature sensor. using one or more hardware component access methods. Within HW abstraction layer 300, BIOS/EC protocols 310 implements abstractions for hardware components such as the fan, battery, thermistor, and the like. BIOS/EC protocols 310 includes common platform services 315, which centralizes hardware component access methods. HW abstraction layer 300 also includes software development kits (SDKs) 320, 330, 340, and 350, implementing third-party hardware abstractions for components such as a processor.

As information handling systems have evolved, the systems often support more than one hardware component access method. Thus, executing within Common Platform Services, application 200 uses access methods in an access method priority list to access (via access 372) platform BIOS layer 370 and to access (via access 374) BIOS telemetry 376 within platform BIOS layer 370. BIOS components are physical things like memory, thermistors, the CPU, etc. There are firmware components in the BIOS that expose access to firmware-local data storage about the components or component level data (if the component supports its own controller, like the battery). The access method priority list prioritizes access methods to one or more hardware components.

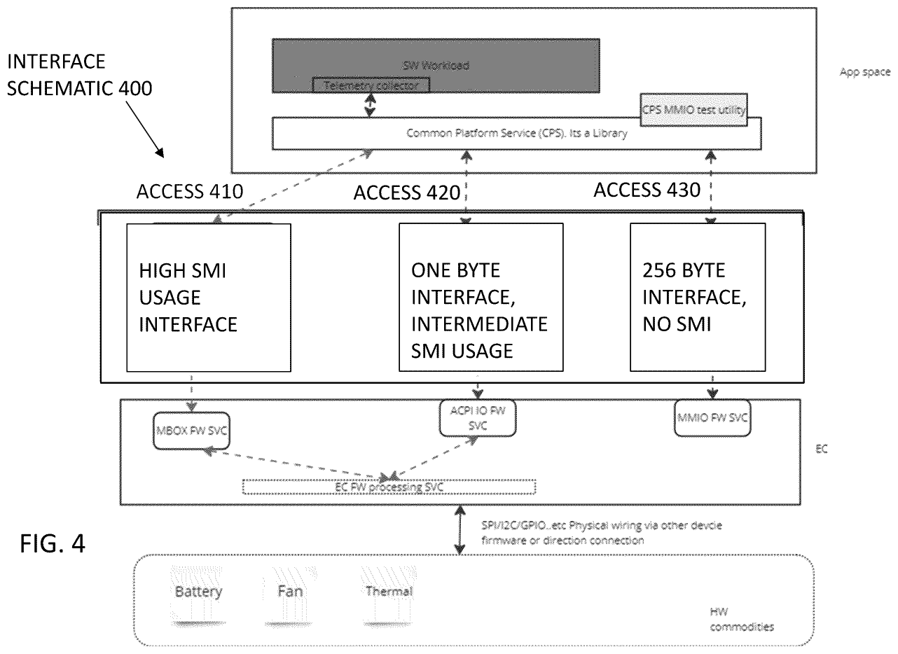

FIG. 4 depicts an example of hardware access methods for use in hardware access method failure recovery, in accordance with an illustrative embodiment. Application 200 in FIG. 2 selects and uses the depicted access methods.

In particular, interface schematic 400 depicts accesses 410, 420, and 430 in an information handling system supporting three hardware component access methods. Access 410 is the slowest access method of the three, requiring use of context switching into system management mode (SMM) via a system management interrupt (SMI) to transfer data and thus referred to as a high SMI usage interface. Access 420 is a one-byte interface with less SMI usage than access 410, thus referred to as an interface with intermediate SMI usage. Access 430 is a 256-byte interface that does not use SMI and thus provides the highest-bandwidth hardware component access method.

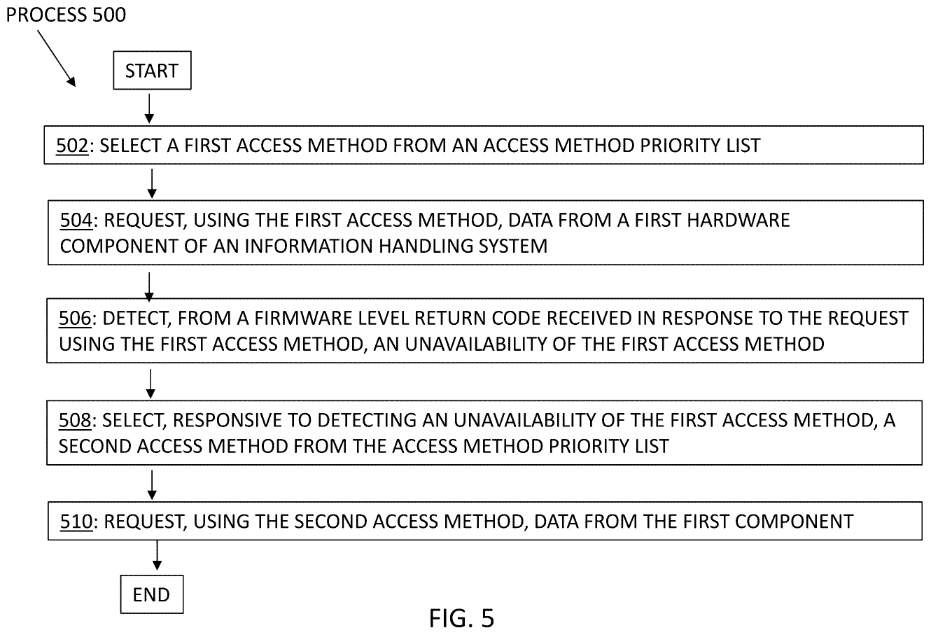

FIG. 5 depicts a flowchart of an example process for hardware access method failure recovery in accordance with an illustrative embodiment. Process 500 can be executed using application 200 in FIG. 2.

In block 502, the process selects a first access method from an access method priority list. In block 504, the process requests, using the first access method, data from a first hardware component of an information handling system. In block 506, the process detects, from a firmware level return code received in response to the request using the first access method, an unavailability of the first access method. In block 508, the process selects, responsive to detecting an unavailability of the first access method, a second access method from the access method priority list. In block 510, the process requests, using the second access method, data from the first component. Then the process ends.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method comprising:
selecting a first access method from an access method priority list;
requesting, using the first access method, data from a first hardware component of an information handling system;
detecting, from a firmware level return code received in response to the request using the first access method, an unavailability of the first access method;
selecting, responsive to detecting an unavailability of the first access method, a second access method from the access method priority list; and
requesting, using the second access method, data from the first hardware component.

2. The computer-implemented method of claim 1, wherein the first access method is a highest-priority access method in the access method priority list.

3. The computer-implemented method of claim 1, further comprising:
recording, based on the firmware level return code, the first access method when used to access the first hardware component as a transient failure.

4. The computer-implemented method of claim 3, further comprising:
detecting, while the first access method when used to access the first hardware component is recorded as a transient failure, from a firmware level return code received in response to a second request using the first access method to access a second hardware component of the information handling system, an availability of the first access method; and
clearing, responsive to detecting the availability of the first access method, the transient failure.

5. The computer-implemented method of claim 1, further comprising:
recording, based on the firmware level return code, the first access method when used to access a hardware component of the same type as the first hardware component as a transient failure.

6. The computer-implemented method of claim 5, further comprising:
detecting, while the first access method when used to access the first hardware component is recorded as a transient failure, from a firmware level return code received in response to a second request using the first access method to access a second hardware component of the information handling system of a different type than the first hardware component, an availability of the first access method; and
clearing, responsive to detecting the availability of the first access method, the transient failure.

7. The computer-implemented method of claim 1, further comprising:
recording, based on the firmware level return code, the first access method when used to access the first hardware component as a permanent failure.

8. The computer-implemented method of claim 7, further comprising:
detecting, while the first access method when used to access the first hardware component is recorded as a permanent failure, a firmware change in the information handling system; and
clearing, responsive to detecting the firmware change, the permanent failure.

9. An information handling system comprising a processor having access to memory media storing instructions executable by the processor to perform operations, comprising:
selecting a first access method from an access method priority list;
requesting, using the first access method, data from a first hardware component of an information handling system;
detecting, from a firmware level return code received in response to the request using the first access method, an unavailability of the first access method;
selecting, responsive to detecting an unavailability of the first access method, a second access method from the access method priority list; and
requesting, using the second access method, data from the first hardware component.

10. The information handling system of claim 9, wherein the first access method is a highest-priority access method in the access method priority list.

11. The information handling system of claim 9, further comprising:
recording, based on the firmware level return code, the first access method when used to access the first hardware component as a transient failure.

12. The information handling system of claim 11, further comprising:
detecting, while the first access method when used to access the first hardware component is recorded as a transient failure, from a firmware level return code received in response to a second request using the first access method to access a second hardware component of the information handling system, an availability of the first access method; and
clearing, responsive to detecting the availability of the first access method, the transient failure.

13. The information handling system of claim 9, further comprising:
recording, based on the firmware level return code, the first access method when used to access a hardware component of the same type as the first hardware component as a transient failure.

14. The information handling system of claim 13, further comprising:
detecting, while the first access method when used to access the first hardware component is recorded as a transient failure, from a firmware level return code received in response to a second request using the first access method to access a second hardware component of the information handling system of a different type than the first hardware component, an availability of the first access method; and
clearing, responsive to detecting the availability of the first access method, the transient failure.

15. The information handling system of claim 9, further comprising:
recording, based on the firmware level return code, the first access method when used to access the first hardware component as a permanent failure.

16. The information handling system of claim 15, further comprising:
detecting, while the first access method when used to access the first hardware component is recorded as a permanent failure, a firmware change in the information handling system; and
clearing, responsive to detecting the firmware change, the permanent failure.

17. A non-transitory computer-readable medium storing software comprising instructions executable by one or more computers which, upon such execution, cause the one or more computers to perform operations comprising:
selecting a first access method from an access method priority list;
requesting, using the first access method, data from a first hardware component of an information handling system;
detecting, from a firmware level return code received in response to the request using the first access method, an unavailability of the first access method;
selecting, responsive to detecting an unavailability of the first access method, a second access method from the access method priority list; and
requesting, using the second access method, data from the first hardware component.

18. The non-transitory computer-readable medium of claim 17, wherein the first access method is a highest-priority access method in the access method priority list.

19. The non-transitory computer-readable medium of claim 17, further comprising:
recording, based on the firmware level return code, the first access method when used to access the first hardware component as a transient failure.

20. The non-transitory computer-readable medium of claim 19, further comprising:
detecting, while the first access method when used to access the first hardware component is recorded as a transient failure, from a firmware level return code received in response to a second request using the first access method to access a second hardware component of the information handling system, an availability of the first access method; and
clearing, responsive to detecting the availability of the first access method, the transient failure.
